(19) United States
(12) Patent Application Publication
(10) Pub. No.: US 2024/0333842 A1
(43) Pub. Date: Oct. 3, 2024

(54) INFORMATION PROCESSING APPARATUS, METHOD OF COOPERATING EXTERNAL SERVICE, AND MEDIUM

(71) Applicant: CANON KABUSHIKI KAISHA, Tokyo (JP)

(72) Inventor: HIROSHI FUSE, Kanagawa (JP)

(21) Appl. No.: 18/616,339

(22) Filed: Mar. 26, 2024

(30) Foreign Application Priority Data
Mar. 29, 2023 (JP) 2023-054057

(51) Int. Cl. H04N 1/00

(52) U.S. Cl. CPC H04N 1/00037; H04N 1/00005; H04N 1/0005; H04N 1/00053; H04N 1/0009; H04N 1/00244; H04N 2201/0094

(57) ABSTRACT

An information processing apparatus uploads data to an external service, determines whether the data upload is successful, downloads the uploaded data from the external service, determines whether the data download is successful, and compares the uploaded data with the downloaded data to determine a state of the external service. It is determined that the state of the external service is a normal state if it is determined that both of the data upload and the data download are successful and that the uploaded data and the downloaded data are identical, and it is determined that the state of the external service is abnormal state if it is determined that the data upload is not successful or that the data download is not successful or that the uploaded data and the downloaded data are not identical. The determined state is stored as a service state.

### BACKGROUND

### Field

The present disclosure relates to an information processing apparatus, a method of cooperating an external service, and a medium.

### Description of the Related Art

In recent years, a variety of cloud services have been used in a variety of application purposes. For example, there exist cloud services corresponding to a various use cases such as a storage service for managing documents and images and an expense calculation service for managing images of receipts and invoices. A multifunctional peripheral (MFP) has a function of cooperating with these cloud services. If this function is used, a document, a receipt or the like from the MFP can be scanned, and the scanned image can be transmitted to a desired cloud service. In addition, the MFP can obtain a response indicating the success/failure of transmission processing from a cloud service to notify a user of the execution result of the transmission processing.

Japanese Patent Laid-Open No. 2011-035871 describes a system in which if the MFP obtains a response indicating the failure (error) of the transmission processing from the cloud service, the MFP registers this cloud service in a blacklist, and this information is shared with another MFP. According to Japanese Patent Laid-Open No. 2011-035871, by causing an MFP in the same network to refer to the blacklist, the user can be notified of the cloud service which cannot perform normal transmission processing via the MFP.

However, in the service cooperation, even if a cloud service as the cooperation destination is truly in an error state, a normal response may be returned. For example, even if image reception is successful on the cloud service side, this image may not be normally stored. The cloud service should return a response indicating “image upload success” to the MFP normally if not only the image can be received but also the image is normally stored. Depending on the cloud service success/failure determination logic, even if the image is not normally stored, the response indicating “image upload success” may be returned to the MFP by only receiving the image. At this time, the MFP displays a situation occurs in which the message “image upload success” on the screen of the MFP in accordance with the response of the cloud service, but does not actually upload the image to the cloud service.

In the technique disclosed in Japanese Patent Laid-Open No. 2011-035871, the success/failure determination is performed based on the response from the cloud service. This technique does not assume a case in which the response “success” is returned although the cloud service processing has failed. For this reason, even if the image is not uploaded to the cloud service, the message “image upload success” is displayed on the MFP screen. In this manner, processing truly performed at the time of service failure cannot be performed. In addition, a problem is posed in which the user may feel distrust of the MFP vendor although the MFP service cooperation in the error state is not transmitted to the user.

### SUMMARY

The present disclosure grasps a state in which a cloud service is not normally operated and achieves processing corresponding to this state. In addition, degradation of the user reliability to the cooperation source vendor of the cloud service is avoided.

The present disclosure have the following arrangement. That is, according to an aspect of the present disclosure, there is provided an information processing apparatus cooperating with an external service, comprising: at least one memory configured to store at least one program; and at least one processor, wherein the at least one program causes the at least one processor to upload data to the external service; determine whether the data upload is successful; download the uploaded data from the external service; determine whether the data download is successful; compare the uploaded data with the downloaded data to determine a state of the external service, wherein it is determined that the state of the external service is a normal state if it is determined that both of the data upload and the data download are successful and that the uploaded data and the downloaded data are identical, and wherein it is determined that the state of the external service is abnormal state if it is determined that the data upload is not successful or that the data download is not successful or that the uploaded data and the downloaded data are not identical; and store the determined state of the external service as a service state.

The present disclosure can grasp a state in which a cloud service is not normally operated and achieves processing corresponding to this state. In addition, degradation of the user reliability to the cooperation source vendor of the cloud service can be avoided.

Further features of the present disclosure will become apparent from the following description of exemplary embodiments with reference to the attached drawings.

### BRIEF DESCRIPTION OF THE DRAWINGS

FIG. 1 is a view showing the overall arrangement of a system;

FIG. 2 is a block diagram showing the hardware arrangement of an MFP;

FIG. 3 is a block diagram showing the hardware arrangement of an MFP cooperation service and a cloud service;

FIG. 4 is a block diagram showing the software arrangement of an entire system;

FIG. 5 is a flowchart showing the processing details of an MFP cooperation service;

FIG. 6 is a sequence chart showing the processing sequence between devices; and

FIGS. 7A and 7B are views showing screens of the MFP.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

### [System Arrangement]

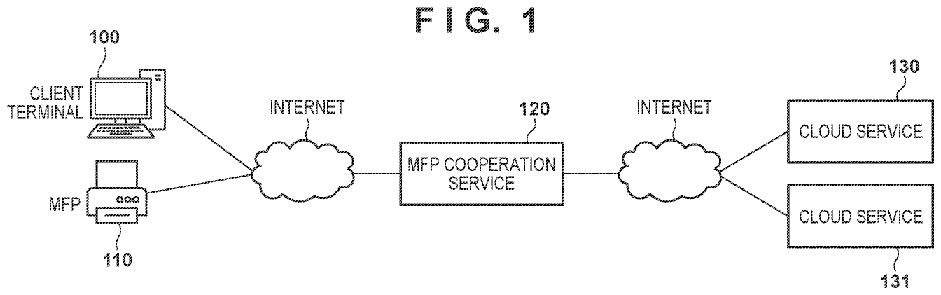

FIG. 1 shows the arrangement of a service cooperation system according to this embodiment. A client terminal 100 is a client terminal for performing setting of each MFP cooperation service 120. An MFP 110 is a multifunctional peripheral having a plurality of functions such as scanner and printer functions. The MFP cooperation service 120 is an example of a relay service for connecting the MFP 110 and an external cloud service 130. The MFP 110 can receive provision of a service by the cloud service 130 via the MFP cooperation service 120. The cloud service 130 and a cloud service 131 are web services used for a variety of application purposes such as a storage, a core system, and a business system. Note that the types and cooperation count of the cloud service of the cooperation destination are not limited to those in this embodiment. Note that the cloud service is sometimes referred to as an external service.

With this arrangement, the MFP 110 can transmit scanned images to the cloud services 130 and 131 via the MFP cooperation service 120. In addition, the MFP 110 can also download the images and metadata stored in the cloud services 130 and 131. Note that in the following description, the image data or image file is sometimes referred to simply an image hereinafter. In addition, in this embodiment, the MFP 110 has a function enough to scan an original to obtain image data uploaded to the cloud service 130 and upload it to the MFP cooperation service 120. By paying attention to this function, the MFP 110 may also be referred to as an image upload apparatus, an image obtaining apparatus, or an image data transmission source or transmission source apparatus.

It is assumed that a method using a mechanism allowing authentication such as OAuth can be used as a method for cooperating and operating a plurality of services in the system of this embodiment. By this technique, cooperation of the MFP cooperation service 120 and the cloud services 130 and 131 can be implemented. For example, an application or another service for issuing an access token to a user authenticated by an authentication server (not shown) and accessing a resource can be accessed upon authentication using this access token.

The system according to this embodiment is constituted by the MFP 110 and the MFP cooperation service 120, but the present disclosure is not limited to this. For example, the MFP 110 may also have a function as a role of the MFP cooperation service 120. Alternatively, the MFP cooperation service 120 may have a connection form in which the MFP cooperation service 120 is arranged in the server on the LAN in place of the Internet. The respective constituent elements are connected to be able to communicate by the network. The network may be any one of a LAN, WAN, a telephone line, a dedicated digital line, an ATM such as the Internet. The network is a communication network implemented by a combination of these networks. The network can be any form if it can transmit or receive data.

### [Hardware Arrangement of MFP]

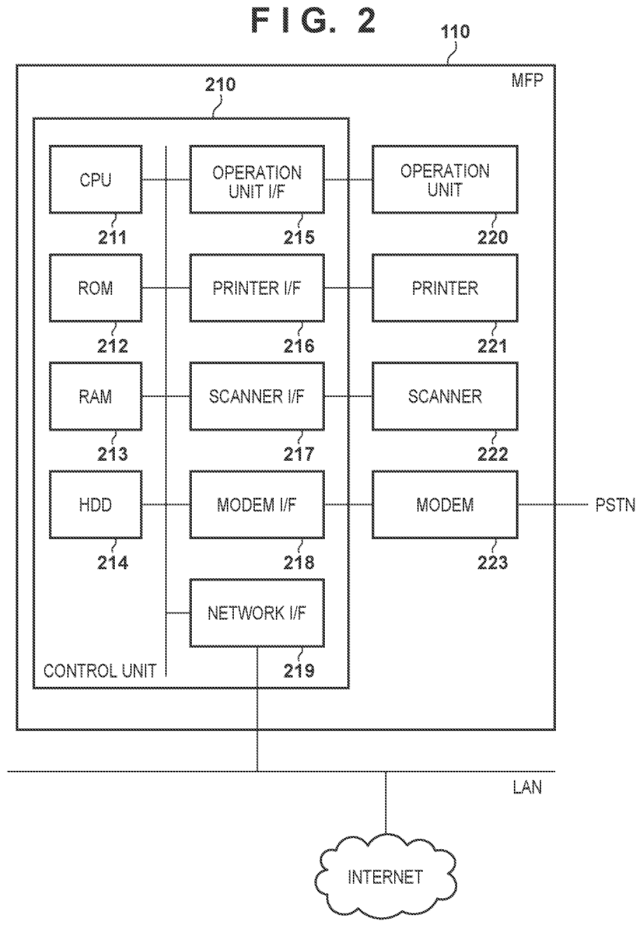

FIG. 2 is a block diagram showing the hardware arrangement of the MFP 110. The MFP 110 includes a control unit 210, an operation unit 220, a printer unit 221, a scanner unit 222, and a modem 223. The control unit 210 includes components 211 to 219 and controls the entire MFP 110.

The CPU 211 reads out a control program stored in the ROM 212 and executes/controls the respective functions of the MFP 110 such as reading/printing/communication. The RAM 213 can be used as a main memory and a temporary storage area such as a work area of the CPU 211. Note that in this embodiment, one CPU 211 executes various processing operations shown in a flowchart to be described later using one memory (the RAM 213 or the HDD 214). However, the present disclosure is not limited to this. For example, a plurality of CPUs and a plurality of RAMs or HDDs may be cooperated to execute each process. The HDD 214 is a mass storage unit for storing image data and various types of programs. An operation unit I/F 215 is an interface for connecting the operation unit 220 and the control unit 210. The operation unit 220 includes a touch panel and a keyboard and accepts an operation/input/instruction by the user. A printer I/F 216 is an interface for connecting the printer unit 221 and the control unit 210. The image data for printing is transferred from the control unit 210 to the printer unit 221 via the printer I/F 216 and is printed on a print medium. A scanner I/F 217 is an interface for connecting the scanner unit 222 and the control unit 210. The scanner unit 222 reads an original set on a document table (not shown) or an Auto Document Feeder (ADF) (not shown) to generate image data and inputs the image data to the control unit 210 via the scanner I/F 217.

The MFP 110 has a copying function of printing and outputting, from the printer unit 221, image data generated by the scanner unit 222 and can transmit an image data file or mail. A modem I/F 218 is an interface for connecting the modem 223 and the control unit 210. The modem 223 communicates the facsimile image data with the facsimile apparatus on the PSTN. A network I/F 219 is an interface for connecting the control unit 210 (MFP 110) to the LAN. The MFP 110 transmits image data and information to each service on the Internet using the network I/F 219 or receives each kind of information.

### [Hardware Arrangement of MFP Cooperation Service and Cloud Service]

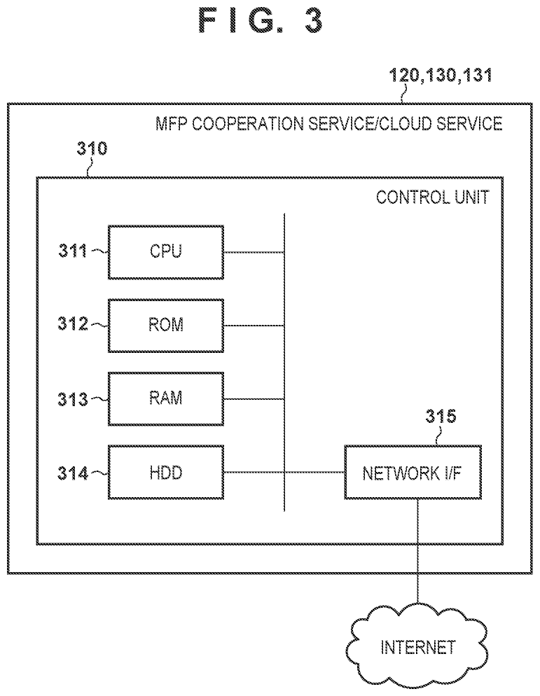

FIG. 3 is a block diagram showing the hardware arrangement of the MFP cooperation service 120 and the cloud services 130 and 131. Note that the service is provided by the server, but may be referred to as the service including the server. Therefore, the hardware arrangement of the service indicates the hardware arrangement of a computer or information processing apparatus serving as the server.

The MFP cooperation service 120 and the cloud services 130 and 131 include a CPU 311, a ROM 312, a RAM 313, a HDD 314, and a network I/F 315. The CPU 311 reads out the control program stored in the ROM 312 and executes various processing operations to control the overall operation. The RAM 313 is used as the main memory and the temporary storage area such as a work area of the CPU 311. The HDD 314 is a mass storage unit for storing image data and various kinds of programs. The network I/F 315 is an interface for connecting the MFP cooperation service 120 and the cloud services 130 and 131 to the Internet. The MFP cooperation service 120 and the cloud services 130 and 131 receive a processing request from another apparatus (the MFP 110) via the network I/F 315 and transmit and receive various kinds of information.

### [Software Arrangement of Overall System]

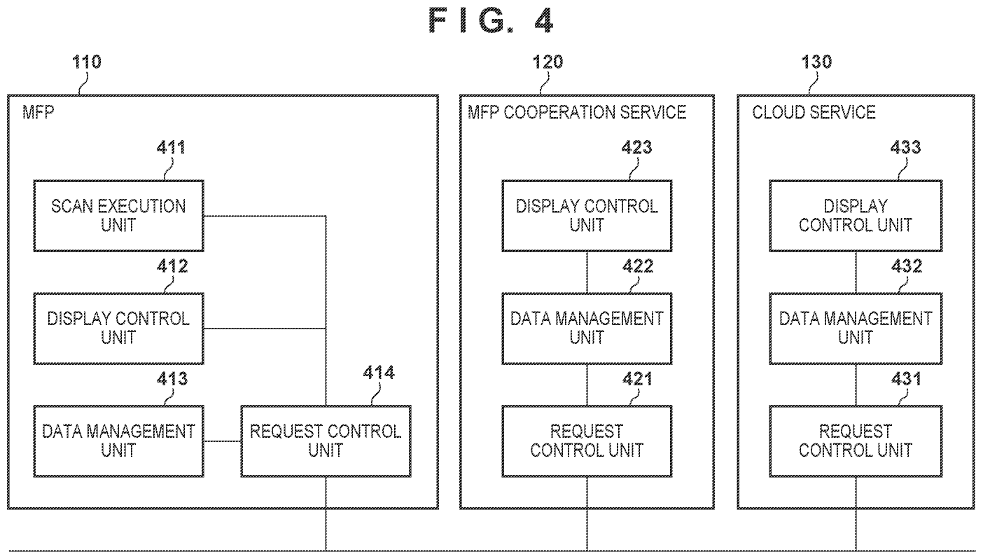

FIG. 4 is a block diagram showing the software arrangement of the entire system according to this embodiment. The MFP 110 includes a scanner execution unit 411, a display control unit 412, a data management unit 413, and a request control unit 414.

The display control unit 412 displays a UI screen for receiving an operation by the user on a liquid crystal display unit having a touch panel function of the operation unit 220 of the MFP 110. For example, the display control unit 412 displays a UI screen for receiving instructions such as an input of authentication information for accessing the MFP cooperation service 120, a scan setting, an operation for starting scan, and a metadata input.

The scanner execution unit 411 executes scan processing based on scan setting corresponding to the user instruction input via the UI screen displayed by the display control unit 412 of the MFP 110. The scanner execution unit 411 reads the original placed on the document table glass or ADF in the scanner unit 222 via the scanner I/F 217, thereby generating image data. The generated image data is sent to the data management unit 413.

The data management unit 413 stores, in the HDD 214, the image data received from the scanner execution unit 411.

The request control unit 414 sends requests for various kinds of processing to the MFP cooperation service 120. For example, the requests for the login to a service and transmission/reception of image data are performed. A protocol such as REST or SOAP is used to exchange information with the MFP cooperation service 120, but any other communication means may be used.

The MFP cooperation service 120 includes a request control unit 421, a data management unit 422, and a display control unit 423.

The request control unit 421 appropriately executes processing corresponding to a processing request from the MFP 110 and transmits the processing request result to the MFP 110. For example, in a case where an image data transmission instruction is received by the cloud service 130 from the MFP 110, the image data received from the MFP 110 is temporarily stored in the data management unit 422 and transmitted to the cloud service 130. In addition, in a case where an image data reception instruction stored in the cloud service 130 is received from the MFP 110, the image data is downloaded from the cloud service 130 and transmitted to the MFP 110.

The data management unit 422 holds the connection information of the cloud service 130 serving as the cooperation destination of the MFP managed by the MFP cooperation service 120, temporarily stored image data, and the like.

The display control unit 423 receives a request from the web browser operated in the client terminal 100 and returns screen configuration information (HTML, CSS, or the like) necessary for the screen display. The user confirms the connection information of the cloud service 130 registered in the MFP cooperation service 120 via the screen displayed by the web browser or change the setting at the time of scan.

The cloud service 130 includes a request control unit 431, a data management unit 432, and a display control unit 433.

The request control unit 431 appropriately executes processing corresponding to the processing request from the MFP cooperation service 120 and transmits the processing request result to the MFP cooperation service 120. For example, in a case where the image data transmission instruction from the MFP cooperation service 120 to the cloud service 130 is received, the image data received from the MFP cooperation service 120 is stored in the data management unit 432. In addition, in a case where the instruction for obtaining the image data stored from the MFP cooperation service 120 to the cloud service 130 is received, the image data designated from the data management unit 432 is obtained, and this image data is transmitted to the MFP cooperation service 120.

The data management unit 432 holds the image data stored in the cloud service 130.

The display control unit 423 receives a request from the web browser operated in the client terminal 100 and returns screen configuration information (HTML, CSS, or the like) necessary for the screen display. The user can refer to the image data or the like stored in the cloud service 130 via the screen displayed by the web browser.

### [Details of Processing of MFP Cooperation Service]

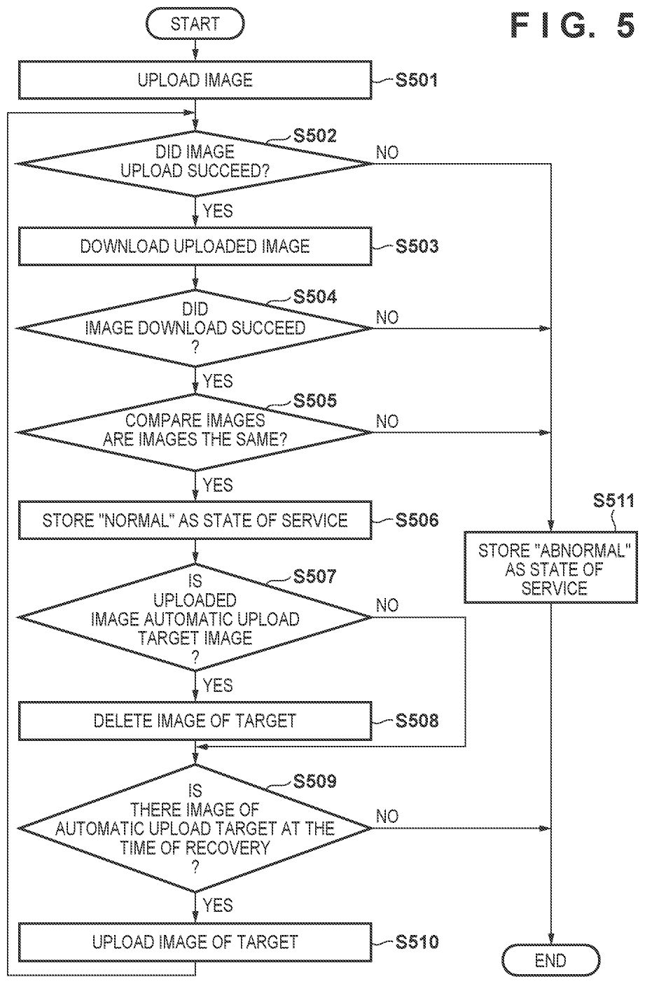

FIG. 5 is a flowchart showing the details of processing for monitoring the service state of the cloud service 130 by the MFP cooperation service 120. This series of processing operations is implemented, in the control unit 310, by causing the CPU 311 to execute the control program stored in the HDD 314, as will be described in detail below.

In this embodiment, the MFP cooperation service 120 repeatedly performs the cloud service 130 every predetermined interval. In addition, the target cloud services are all cloud services cooperated by the MFP cooperation service 120. For example, this flowchart may be executed as parallel processing for a plurality of cloud services every predetermined time, for example, one min.

In step S501, the request control unit 421 of the MFP cooperation service 120 sends an image upload request to the cloud service 130. An image to be uploaded may be a predetermined test image. In step S502, the request control unit 421 determines whether the image upload succeeds. If the image upload succeeds, the cloud service 130 transmits the file path of the image data as a response. If the image upload succeeds, the process advances to step S503; otherwise, the process advances to step S511.

In step S503, the request control unit 421 of the MFP cooperation service 120 sends the image download request to the cloud service 130. In step S504, the request control unit 421 determines whether the image download succeeds. The image download request designates the file path of the image data received as the response to the image upload request in step S501. If the image download succeeds, the process advances to step S505; otherwise, the process advances to step S511.

In step S505, the request control unit 421 of the MFP cooperation service 120 compares the image data uploaded in step S501 with the image data downloaded in step S503 to determine that these data are identical. If YES in step S505, the process advances to step S506; otherwise, the process advances to step S511.

In step S506, the request control unit 421 of the MFP cooperation service 120 determines that the state of the cloud service 130 is normal. This information is stored in the data management unit 422.

In step S507, it is determined whether the image uploaded in step S501 is the image data as the automatic upload target at the time of recovery of the cloud service 130. The automatic upload at the time of recovery is an optional setting for setting automatic upload in the MFP cooperation service 120 from the MFP 110 in a case where the cloud service 130 cannot normally upload the image due to an error or the like. If the automatic upload at the time of recovery is set, the MFP cooperation service 120 stores the image that cannot be uploaded. If the upload enable state is set, the image is retried to be uploaded. If it is determined that the image uploaded in step S501 is the image data serving as the automatic upload target of the cloud service 130 at the time of recovery, the process branches to step S508; otherwise, the process branches to step S509.

In step S508, the image data which succeeds the automatic upload at the time of recovery is deleted. In step S509, it is determined whether there is an image serving as the automatic upload target at the time of recovery. If YES in step S509, the image serving as the target is uploaded to the cloud service 130 in step S510. After that, the process branches to step S502.

In step S511, the request control unit 421 of the MFP cooperation service 120 determines that the state of the cloud service 130 is abnormal, and this information is stored in the data management unit 422.

For example, in steps S506 and S511, as a service state list, the cloud service names and the service states are stored in association with each other as shown in Table 1.

TABLE 1

| CLOUD SERVICE NAME | SERVICE STATE |
|---|---|
| SERVICE A | NORMAL |
| SERVICE B | NORMAL |
| SERVICE C | ABNORMAL |

As described above, a method of confirming whether “the image data is correctly uploaded to the cloud service after uploading” by comparing the uploaded image data with the downloaded image data has been described above. This enables the vilification for “each cloud service operates normally, and an expected result is obtained”. In addition, since this flowchart is periodically, repeatedly executed every predetermined interval, the service state of each cloud service is switched from the normal state to the abnormal state or from the abnormal state to the normal state. In a case where the state of the cloud service of the cooperation destination is abnormal, since the service cooperation function of the MFP cannot be used normally, a notification such as a mail to the user or the cooperation source vendor developer may be sent. For example, information indicating an item to be checked, such as a fact that the image data received from the cloud service is not normally processed, may be added as the notification contents to the developer, and a message for prompting the developer to try to recover the service as soon as possible may be sent.

[Procedure of Processing between Devices]

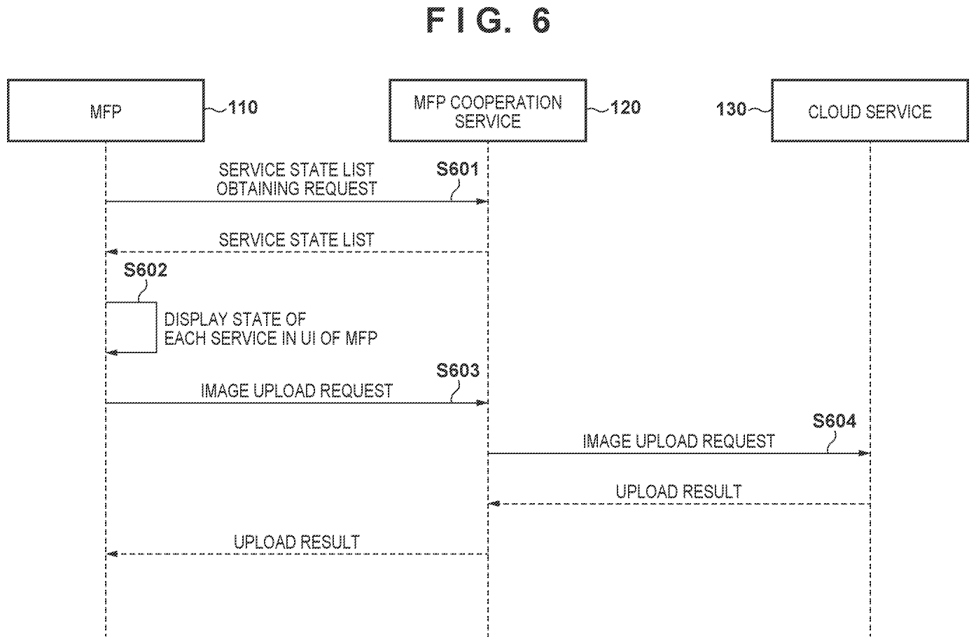

FIG. 6 is a sequence chart showing the procedure of processing between the devices when the MFP 110 scans a document to upload the image to the cloud service 130. Here, the data exchange between the devices will be mainly described.

This processing is started when detecting that the UI screen (the display control unit 412) of the MFP is operated.

In S601, the MFP 110 transmits a service state list obtaining request to the MFP cooperation service 120 and obtains the service state list of Table 1 from the MFP cooperation service 120.

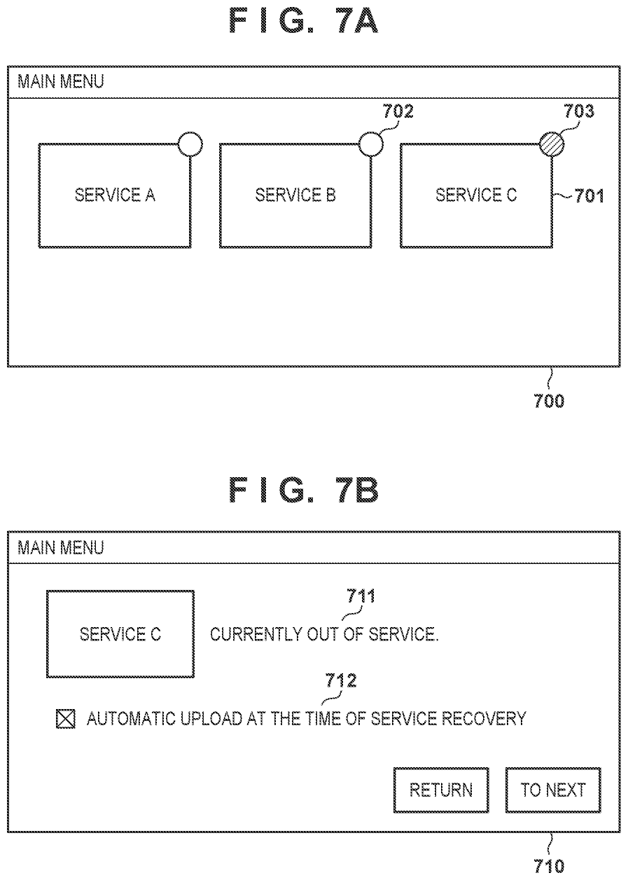

In S602, the MFP 110 displays a main screen 700 in FIG. 7A on the touch panel. A button 701 for uploading the image to each cloud service 130 connected via the MFP cooperation service 120 is parallelly displayed on the main screen 700. At this time, the service state list obtained in S601 is made to correspond to the button 701 as the state of each cloud service. For example, if the service state is normal as in a service A or B, a hollow dot 702 is displayed. If the service state is abnormal like a service C, a solid dot 703 is displayed. Although the service state is indicated by a dot in this embodiment, another drawing method may be used. The MFP 110 has different processing executed next depending on a pressed button. For example, if a service (the service A or B) whose service state is normal is pressed, the process advances to S603. On the other hand, a service (the service C) whose service state is abnormal is pressed, a service detail screen 710 shown in FIG. 7B is displayed.

The service detail screen 710 includes a message 711 indicating a service state and an alternative choice 712. If the alternative choice 712 is set ON, the “next” button is validated. If this button is pressed, the process advances to S603. Here, the alternative choice is the automatic upload at the time of recovery of the service.

In S603, the MFP 110 transmits the image upload request to the MFP cooperation service 120. The MFP cooperation service 120 extracts image data from the received request and temporarily stores the extracted image data in the data management unit 422. The image data included in the request is the image data scanned by the MFP 110.

If the MFP cooperation service 120 selects a cloud service whose service state is normal in S602, the MFP cooperation service 120 transmits the image upload request to the cloud service 130 and obtains the upload result in S604. After that, the MFP cooperation service 120 returns the obtained upload result to the MFP 110, and processing ends. On the other hand, if a cloud service whose service state is abnormal is selected in S602, the MFP cooperation service 120 does not transmit the image upload request and automatically transmits the image upload request when the service state is changed from the abnormal state to the normal state.

The method of displaying the state of each cloud service 130 on the UI screen of the MFP has been described above. Accordingly, the user can easily grasp whether the cloud service 130 can be normally used. In addition, if the cloud service 130 cannot be normally used, the image data is temporarily stored in the MFP cooperation service 120. This makes it possible to automatically transmit the image data to the cloud service 130 when the cloud service 130 is changed to a usable state. In this manner, the state of the cloud service 130 can be accurately grasped, and even the cooperative service and MFP can achieve the processing in accordance with the state of the service and MFP.

### Modification

This embodiment has described the method of temporarily holding image data transmission in accordance with the service state of the cloud service 130 as the alternative choice 712. However, another method may be presented as an alternative. For example, a guidance for transmitting the image data to the mail address of the user and manually uploading the image data to the cloud service 130 may be prompted. According to this embodiment, the MFP 110 obtains the service state of each cloud service 130 from the MFP cooperation service 120, but the MFP cooperation service 120 may send the notification of the service state of each cloud service 130 to the MFP 110.

In addition, in FIG. 6, an upload result may be received for the image upload, and if the upload result indicates a failure, the image may be uploaded again immediately or upon the elapse of a predetermined time. Assuming a possibility that the uploaded image is not stored, the cloud service 130 downloads the image uploaded as described with reference to FIG. 5, and it may be determined whether the downloaded image matches the uploaded image.

The UI screen in FIG. 7A, 7B, or 8 may be a screen provided by the MFP 110. Alternatively, the web browser executed by the MFP 110 may send a request to the web service serving as the front end of the MFP cooperation service 120 and the web browser receives the web page received as a response to this request. In this case, the MFP 110 does not receive the service state of the cloud service 130 from the MFP cooperation service 120 and can display the service state on the UI shown in FIG. 7A, 7B, or 8. In this case, the screen in FIG. 7A or 7B requests the screen in FIG. 7A or 7B by the HTTP request as the request in S601 in FIG. 6, and this screen is obtained and displayed. In this case, if the service C is selected, the screen in FIG. 8 is requested and obtained, and this screen is displayed.

In addition, predetermined image data is uploaded in step S501 in FIG. 5. If there is image data serving as the automatic upload target at the time of service recovery, this image data may be uploaded. In this case, if the upload and download succeed, and the image data are compared and determined to be identical, the upload of the image data is determined to succeed. As described above, a data amount exchanged between the MFP cooperation service 120 and the cloud service 130 can be reduced.

Any one of the file name and upload timing of the image data waiting for the uploading, or image data itself, which are held in the MFP cooperation service 120, may be obtained from the client terminal 100 or the MFP 110.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-054057, filed Mar. 29, 2023 which is hereby incorporated by reference herein in its entirety.

What is claimed is:

1. An information processing apparatus cooperating with an external service, comprising:
at least one memory configured to store at least one program; and
at least one processor,
wherein the at least one program causes the at least one processor to
upload data to the external service;
determine whether the data upload is successful;
download the uploaded data from the external service;
determine whether the data download is successful;
compare the uploaded data with the downloaded data to determine a state of the external service, wherein it is determined that the state of the external service is a normal state if it is determined that both of the data upload and the data download are successful and that the uploaded data and the downloaded data are identical, and wherein it is determined that the state of the external service is abnormal state if it is determined that the data upload is not successful or that the data download is not successful or that the uploaded data and the downloaded data are not identical; and
store the determined state of the external service as a service state.

2. An apparatus according to claim 1, wherein the data upload, the data download, and the data comparison are repeated every predetermined interval.

3. An apparatus according to claim 1, wherein in a case where it is stored that the service state is the normal state, received data is uploaded to the external service in response to a request from a transmission source of the received data.

4. An apparatus according to claim 1, wherein in a case where it is stored that the service state is the abnormal state, received data requested from a transmission source is held, and wherein the held data is uploaded to the external service if the service state becomes normal state.

5. An apparatus according to claim 1, wherein the stored service state of the external service is transmitted to a transmission source in response to a request from the transmission source of received data.

6. An apparatus according to claim 1, wherein a screen for selecting any of a plurality of external services is provided to a transmission source in response to a request from the transmission source of received data, and
service states of the plurality of external services are displayed on the screen.

7. An apparatus according to claim 6, wherein in a case where an external service whose service state is not normal is selected on a screen for selecting the external service, a screen for accepting an instruction for uploading data to the external service after the service state becomes normal is provided to the transmission source.

8. An apparatus according to claim 1, wherein the data is image data.

9. A non-transitory computer-readable storage medium storing a program for causing a computer to execute processing if the program is loaded and executed, wherein the processing includes:
uploading data to an external service;
determining whether the data upload is successful;
downloading the uploaded data from the external service;
determining whether the data download is successful;
comparing the uploaded data with the downloaded data;
determining a state of the external service, wherein it is determined that the state of the external service is a normal state if it is determined that both of the data upload and the data download are successful and that the uploaded data and the downloaded data are identical, and wherein it is determined that the state of the external service is abnormal state if it is determined that the data upload is not successful or that the data download is not successful or that the uploaded data and the downloaded data are not identical; and
storing the determined state of the external service as a service state.

10. A method of cooperating an external service with an information processing apparatus cooperating with the external service, the method comprising:
uploading data to the external service,
determining whether the data upload is successful;
downloading the uploaded data from the external service;
determining whether the data download is successful;
comparing the data uploaded with the data downloaded;
determining a state of the external service, wherein it is determined that the state of the external service is a normal state if it is determined that both of the data upload and the data download are successful and that the uploaded data and the downloaded data are identical, and wherein it is determined that the state of the external service is abnormal state if it is determined that the data upload is not successful or that the data download is not successful or that the uploaded data and the downloaded data are not identical; and
storing the determined state of the external service as a service state.
